(19) United States
(12) Patent Application Publication
(10) Pub. No.: US 2012/0307517 A1
(43) Pub. Date: Dec. 6, 2012

(54) ELECTRONIC CANDLE

(75) Inventor: Yingqi Ding, Nantong City (CN)

(73) Assignee: NANTONG YA TAI CANDLE ARTS & CRAFTS CO., LTD., Nantong City (CN)

(21) Appl. No.: 13/209,931

(22) Filed: Aug. 15, 2011

(30) Foreign Application Priority Data
Jun. 1, 2011 (CN) 201110146069.1

(51) Int. Cl. F21V 35/00

(52) U.S. Cl. 362/569; 362/161

(57) ABSTRACT

The present invention discloses an electronic candle, consisting of a body which is internally provided with a cavity. The said cavity is internally mounted an illuminator and an electronic device controlling the illuminator. The said illuminator is connected to a light conductor which extends to the surface of the body through the cavity top to form the section of a light-conducting wick. The invention has advantages of reasonable structure, safe application, good effect and aesthetic look of body by sputtering away lights.

### FIELD OF THE INVENTION

The present invention relates to a candle, particularly to an illuminant electronic candle.

### BACKGROUND OF THE INVENTION

The ignition-typed candle in the prior art is cheap in the cost, but with hidden safety troubles. There are pluralities of commercial electronic candles, wherein most adopt plastic bodies, and a few adopt the wax candle bodies with the illuminator positioned on the electronic wick in a poor effect. In the foregoing arrangement, the electronic candle is lit merely at the wick, does not illuminate at the body, thus failed to better present the engraved style and shape with lights, especially, even failed to exhibit the aesthetic look of body with sparks in the darkness.

### SUMMARY OF THE INVENTION

Object of the present invention: The present invention is to settle the technical shortcoming in the prior art, to provide a safe true aesthetic electronic candle.

The technical schemes in the invention: an electronic candle, consisting of a body which is internally provided with a cavity. The foregoing cavity is internally mounted an illuminator and an electronic device controlling the illuminator. The said illuminator is connected to a light conductor which extends to the surface of the body through the cavity top to form a section of light-conducting wick.

As a further improvement of the invention, the said light conductor is an optical fiber which is good in the light conducting effect.

As a further improvement of the invention, the said illuminator is an LED flashlight, flashing the illuminator, transmitting the light for the light conductor in a true flashing effect just as the candle is burnt.

As a further improvement of the invention, the said light conducting wick is provided with a light-blocking body at a bottom section. The said light-blocking body is a black or white wick dyed or wrapped with a black or white plastic sheet, allowing a truer effect of simulative electronic candle just as the wick bottom does not illuminate or burnt black.

As a further improvement of the invention, the said illuminator and light conductor are covered with a fixing tube at the contact portion to fasten the bottom of the light conductor and the top of the illuminator in excluding the displacement between the said illuminator and light conductor against that the light from the illuminator fails to radiate through the light conductor. Or a transparent lampshade is deposed on the said illuminator. The said lampshade is connected to the said light conductor on the top, converging and radiating the light through the light conductor which is connected to the lampshade top.

As a further improvement of the invention, the said candle bode is provided with a driver of an electronic device without affecting the aesthetic look of the body in a better true effect.

The body of the electronic candle in the invention may be either a wax or plastic body, or a body with wax liquid or wax in a glass or transparent container or candle-shaped illuminator. The said illuminator adopts the light conducting technology of the light conductor in the present invention.

Advantages: the present invention is reasonable in the structure. The light from the illuminator in the cavity of the body is transmitted to the light conductor wick on the candle surface with flash effect, thus safety in use and with good effect. The lower section of the wick is provided with a black segment with a true candle-lighting effect. The illuminator in the cavity of the body also radiates through the semi-transparent candle aesthetically. The invention achieves illuminating the body and wick without an additional power supply, thus saving the energy.

### BRIEF DESCRIPTION OF THE DRAWINGS

FIG. 1 is a sectional view of embodiment in the invention;

FIG. 2 is a sectional view of the other embodiment in the invention.

### EMBODIMENTS

The present invention is hereinafter further instructed with accompanying drawings and embodiments. The protection scope of the invention includes, nevertheless not limited to the following embodiments, complete with the simple alternations of technical features in the similar or equal technical effects.

### Embodiment 1

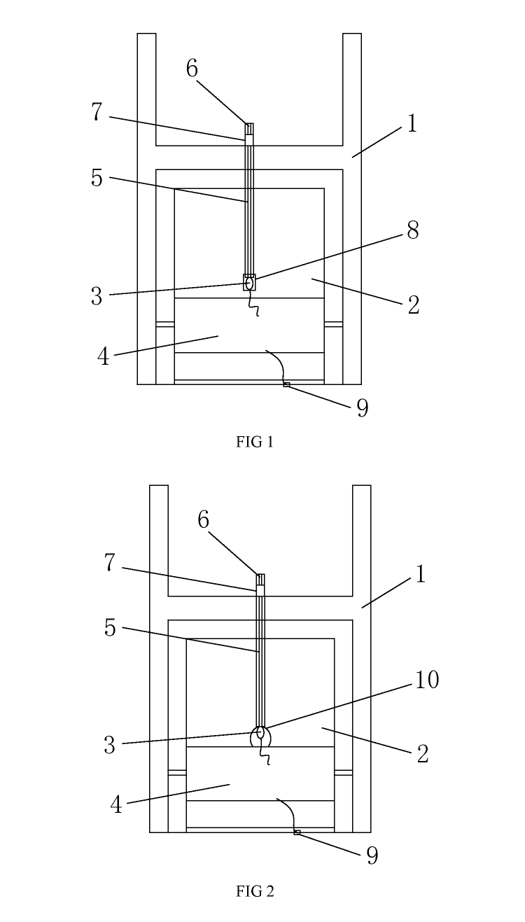

An electronic candle, consisting of a plastic body 1 which is internally provided with a cavity 2 as illustrated in FIG. 1. The said cavity 2 is mounted an illuminator 3 and an electronic device 4 controlling the illuminator 3, the said illuminator 3 is an LED flashlight, the said body 1 is provided with a driver 9 of the electronic control device 4 at the bottom, the said illuminator 3 is connected with a light conductor 5, the said illuminator 3 and light conductor 5 are covered with a fixing tube 8 at a contact portion, the said light conductor 5 extends to the surface on the said body 1 through the said cavity 2 top to form the section of a light conducting wick 6, the light conducting wick 6 wrapped into a black light-blocking wick 7 with a segment of black plastic sheet at lower section.

### Embodiment 2

An electronic candle, consisting of a wax body 1 which is internally provided with a cavity 2 as illustrated in FIG. 1, the said cavity 2 is mounted an illuminator 3 and an electronic device 4 controlling the illuminator 3, the said illuminator 3 is an LED flashlight, the said body 1 is provided with a driver 9 of an electronic control device 4 at the bottom, the said illuminator 3 is connected with an optical fiber conductor 5, the said illuminator 3 and optical fiber conductor 5 are covered with a fixing tube 8 at a contact portion, the said optical fiber conductor 5 extends to the surface on the said body 1 through the said cavity 2 top to form the section of an optical fiber wick 6, the optical fiber wick 6 wrapped into a black light-blocking wick 7 with the segment of black plastic sheet at the lower section.

### Embodiment 3

An electronic candle, consisting of a wax body 1 which is internally provided with a cavity 2 as illustrated in FIG. 2, the said cavity 2 is mounted an illuminator 3 and an electronic device 4 controlling the illuminator 3, the said illuminator 3 is an LED flashlight, the said body 1 is provided with a driver 9 of an electronic control device 4 at the bottom, the said illuminator 3 is connected with an optical fiber conductor 5, the said illuminator 3 is provided with a transparent lampshade 10 which is connected to an optical fiber conductor 5 on the top, the said optical fiber conductor 5 extends to the surface on the said body 1 through the said cavity 2 top to form the section of an optical fiber wick 6, the optical fiber wick 6 wrapped into a black light-blocking wick 7 with the segment of black plastic sheet at the lower section.

1. An electronic candle, comprising a body (1) wherein the said body (1) is internally provided with a cavity (2) which is mounted with an illuminator (3) and an electric device (4) controlling the illuminator (3), the said illuminator (3) is connected to a light conductor (5) which extends to the surface of the body (1) top through the said cavity (2) top to form the section of a light-conducting wick (6).

2. The electronic candle according to claim 1, wherein the said light conductor (5) is an optical fiber.

3. The electronic candle according to claim 1, wherein the said illuminator (3) is an LED flashlight.

4. The electronic candle according to claim 1, wherein the said light conducting wick (6) is provided with a light-blocking body (7) in a bottom segment.

5. The electronic candle according to claim 4, wherein the said light-blocking body (7) is a black or white wick dyed or wrapped with a black or white plastic sheet.

6. The electronic candle according to claim 1, wherein the said illuminator (3) and the light conductor (5) are covered with a fixing tube (8) at the contact portion, or a transparent lampshade (10) connected to the said light conductor (5) on the top is deposed on the said illuminator (3).

7. The electronic candle according to claim 1, wherein the said body (1) is provided with a driver (9) of the electronic control device (4).
